(19) United States
(12) Patent Application Publication
(10) Pub. No.: US 2013/0275096 A1
(43) Pub. Date: Oct. 17, 2013

(54) Solder Joint Fatigue Life Prediction Method

(71) Applicant: INTERNATIONAL BUSINESS MACHINES CORPORATION, (US)

(72) Inventors: Akifumi Yoshimura, Tokyo (JP); Keishi Okamoto, Kanagawa (JP)

(21) Appl. No.: 13/801,162

(22) Filed: Mar. 13, 2013

(30) Foreign Application Priority Data
Apr. 16, 2012 (JP) JP2012093407

(51) Int. Cl. G06F 17/50

(52) U.S. Cl. CPC G06F 17/5018
USPC 703/2

(57) ABSTRACT

A solder joint fatigue life predicting method includes: establishing a maximum temperature, a minimum temperature, and a temperature cycle frequency in a field environment; establishing a maximum temperature, a minimum temperature, and a temperature cycle frequency in a laboratory environment for accelerated testing; implementing the accelerated testing to measure test fatigue life until failure of the product; determining exponents for the ramp rate and dwell time in a novel acceleration factor equation which is represented using the ramp rates and dwell times of the field environment and the laboratory environment from profile data of the temperature cycle in the field environment, from profile data of the temperature cycle in the laboratory environment, and from test fatigue life data, and calculating an acceleration factor by plugging these exponents into the acceleration factor equation; and calculating field fatigue life of the product from the calculated acceleration factor and measured test fatigue life.

### BACKGROUND

1. Technical Field

The present invention relates to predicting the fatigue life of a solder joint, and more specifically to a method for predicting the fatigue life of a solder joint using accelerated testing.

2. Background Art

The Modified Coffin-Manson (Norris-Landzberg) Equation is the most commonly used method for predicting electrical component solder joint fatigue life. This equation is expressed as follows.

$$\begin{matrix} Equation 1 & \\ AF = {( \frac{Δ {T}_{field}}{Δ {T}_{lab}} )}^{- n} \times {( \frac{{F}_{field}}{{F}_{lab}} )}^{m} \times {e}^{\frac{{E}_{a}}{R} ( \frac{1}{{T}_{max\_field}} - \frac{1}{{T}_{max\_lab}} )} & ( Equation 1 )\end{matrix}$$

In Equation 1, the acceleration factor (AF) is a number representing the degree to which results from accelerated testing are accelerated relative to the field environment. The index “field” represents the field environment on the market, and “lab” represents the laboratory environment. ΔT_{field} and ΔT_{lab} are the difference between the Tₘₐₓ (maximum temperature) and the Tₘᵢₙ (minimum temperature) in a temperature cycle test repeating high and low temperatures. F is the frequency of the temperature cycle (representing the number of rising temperature and falling temperature cycles within a given period of time), F_{field} is the temperature cycle frequency in the field environment, and F_{lab} is the temperature cycle frequency in the laboratory environment. Tₘₐₓ_{_{—}}_{field} is the maximum temperature in the field environment, and Tₘₐₓ_{_{—}}_{lab} is the maximum temperature in the laboratory environment. Eₐ is the activation energy, and R is the Boltzmann Constant.

The activation energy Eₐ is a value (constant) determined from experimental results. The value used for 5Sn-95Pb solder is usually 0.123 eV in fatigue life estimates. The Boltzmann Constant R is 8.6159×10⁻⁵ eV/k (physical constant). The exponent n for ΔT (ΔT_{field} and ΔT_{lab}) is a value (constant) determined from experimental results, with n=1.9 used for 5Sn-95Pb solder, and n=2.1 used for Pb-free solder. The exponent m for F (F_{field} and F_{lab}) is a value (constant) determined using Norris-Landsberg testing, where m=⅓. In accelerated testing, the ΔT, F and Tₘₐₓ for the field environment (field) and the laboratory environment (lab) are known, and can be used in the calculation along with the constants to predict the fatigue life in the field environment (field) from experimental results. For example, when the test fatigue life of an experimental solder joint is 3,000 cycles, and the acceleration factor AF derived from the Modified Coffin-Manson Equation is 4.5, the following fatigue life is estimated for the field environment of the market: 3,000 cycles×4.5 (acceleration factor)=13,500 cycles.

The fatigue life of the solder is predicted using finite element analysis, and the strain energy density is used as one of the parameters in predicting the fatigue life of the solder. The acceleration factor modeled and calculated in the finite element analysis is in harmony with actual experimental results.

Also, methods for predicting the fatigue life of a solder joint have been proposed in which the crack growth rate of the solder joint is determined and used. These fatigue life prediction methods have been disclosed in the following patent literature:

### 1. Japanese Laid-open Patent Publication No. 2005-148016

### 2. Japanese Laid-open Patent Publication No. 2008-2869

### 3. Japanese Laid-open Patent Publication No. 2012-18107

### SUMMARY

An aspect of the present invention is a method for predicting the fatigue life of a solder joint in a product joined by soldering, the method including the steps of: establishing a maximum temperature Tₘₐₓ_{_{—}}_{field}, a minimum temperature Tₘᵢₙ_{_{—}}_{field}, and a temperature cycle frequency F_{field} in a field environment of the product; establishing a maximum temperature Tₘₐₓ_{_{—}}_{lab}, a minimum temperature Tₘᵢₙ_{_{—}}_{lab}, and a temperature cycle frequency F_{lab} in a laboratory environment for accelerated testing of the product; implementing the accelerated testing of the product to measure a test fatigue life N_{lab} until failure of the product; determining exponent m₁ for the ramp rate and exponent m₂ for the dwell time in Equation 2 below, which is represented using the ramp rate Ramp field and the dwell time Dwell_{field} of the field environment, and the ramp rate Ramp lab and the dwell time Dwell_{lab} of the laboratory environment from the profile data of a temperature cycle using the established maximum temperature Tₘₐₓ_{_{—}}_{field}, the minimum temperature Tₘᵢₙ_{_{—}}_{field}, and the temperature cycle frequency F_{field} of the field environment, from the profile data of a temperature cycle using the established maximum temperature Tₘₐₓ _{_{—}}_{lab}, the minimum temperature Tₘᵢₙ_{_{—}}_{lab}, and the temperature cycle frequency F_{lab} of the laboratory environment, and from the measured data of the test fatigue life N_{lab}, and calculating an acceleration factor AF by plugging the determined exponents m₁ and m₂ into Equation 2; and calculating a field fatigue life N_{field} of the product from the calculated acceleration factor AF and the test fatigue life N_{lab} (N_{field}=AF×N_{lab}).

$$\begin{matrix} Equation 2 & \\ AF = {( \frac{Δ {T}_{field}}{Δ {T}_{lab}} )}^{- n} \times {( \frac{{Ramp}_{field}}{{Ramp}_{lab}} )}^{{m}_{1}} \times {( \frac{{Dwell}_{field}}{{Dwell}_{lab}} )}^{{m}_{2}} \times {e}^{\frac{{E}_{a}}{R} ( \frac{1}{{T}_{max\_field}} - \frac{1}{{T}_{max\_lab}} )} & ( Equation 2 )\end{matrix}$$

ΔT_{field}=Tₘₐₓ_{_{—}}_{field}−Tₘᵢₙ_{_{—}}_{field}

ΔT_{lab}=Tₘₐₓ_{_{—}}_{lab}−Tₘᵢₙ_{_{—}}_{lab}

### n: Constant Determined By Solder

### Eₐ: Activation Energy

### R: Boltzmann Constant

As understood by those skilled in the art, “ramp rate” is the rate at which the temperature rises to a high temperature or falls to a low temperature (unit: ° C./hour), and “dwell time” is the retention time at a predetermined high temperature or low temperature (unit: hours).

In an embodiment, the step for calculating the acceleration factor AF further includes, when determining the exponent m₁ for the term of the ramp rates Ramp_{field} and Ramp_{lab}, determining whether or not the size of the ramp rate RampUp_{lab} and the ramp rate RampDown_{lab} for a rising temperature and a falling temperature in the temperature cycle of the laboratory environment for the ramp rate Ramp_{lab} are the same or different.

In an embodiment, when it has been determined that the size of the ramp rate RampUp_{lab} and the ramp rate RampDown_{lab} for a rising temperature and a falling temperature in the temperature cycle of the laboratory environment are the same, a function is derived representing the test fatigue life N_{lab} using a ramp rate Ramp_{lab} corresponding to a ramp rate RampUp_{lab} or RampDown_{lab} for a rising or falling temperature, and a correlation is determined between the test fatigue life N_{lab} and the ramp rate Ramp_{lab}.

In an embodiment, when it has been determined in the determination of a correlation between the test fatigue life N_{lab} and the ramp rate Ramp_{lab} that there is no correlation, m₁=0, and the ramp rate term [Ramp_{field}/Ramp_{lab}]^{m1}=1.

In an embodiment, when it has been determined in the determination of a correlation between the test fatigue life N_{lab} and the ramp rate Ramp_{lab} that there is a correlation, a linear function representing a normalized test fatigue life N_{lab} using a normalized ramp rate Ramp_{lab} is derived from the function representing the test fatigue life N_{lab} using the ramp rate Ramp_{lab}, m₁ is determined from the slope of the linear function, and the ramp rate term [Ramp_{field}/Ramp_{lab}]^{m1} is calculated.

In an embodiment, when it has been determined that the size of the ramp rate RampUp_{lab} and the ramp rate RampDown_{lab} for a rising temperature and a falling temperature in the temperature cycle of the laboratory environment are different, a function is derived representing the test fatigue life N_{lab} using the ramp rate RampUp_{lab} during a rising high temperature and the correlation is determined between the test fatigue life N_{lab} and the ramp rate RampUp_{lab} during a rising high temperature, and a function is derived representing the test fatigue life N_{lab} using the ramp rate RampDown_{lab} during a falling low temperature and the correlation is determined between the test fatigue life N_{lab} and the ramp rate RampDown_{lab} during a falling low temperature.

In an embodiment, when it has been determined in the determination of a correlation between the test fatigue life N_{lab} and the ramp rate during a rising high temperature RampUp_{lab} that there is no correlation, m₁ₐ=0 and [RampUp_{field}/RampUp_{lab}]^{m1a}=1 for [RampUp_{field}/RampUp_{lab}]^{m1a} constituting a portion of the ramp rate term [Ramp_{field}/Ramp_{lab}]^{m1}.

In an embodiment, when it has been determined in the determination of a correlation between the test fatigue life N_{lab} and the ramp rate during a rising high temperature RampUp_{lab} that there is a correlation, a linear function representing a normalized test fatigue life N_{lab} using a normalized ramp rate during a rising high temperature RampUp_{lab} is derived from a function representing the test fatigue life N_{lab} using the ramp rate during a rising high temperature RampUp_{lab}, m₁ₐ is determined for [RampUp_{field}/RampUp_{lab}]^{m1a} constituting a portion of the ramp rate term [Ramp_{field}/Ramp_{lab}]^{m1} from the slope of the linear function, and [RampUp_{field}/RampUp_{lab}]^{m1a} is calculated.

In an embodiment, when it has been determined in the determination of a correlation between the test fatigue life N_{lab} and the ramp rate during a falling low temperature RampDown_{lab} that there is no correlation, m_{1b}=0 and [RampDown_{field}/RampDown_{lab}]^{m1b}=1 for [RampDown_{field}/RampDown_{lab}]^{m1b} constituting another portion of the ramp rate term [Ramp_{field}/Ramp_{lab}]^{m1}.

In an embodiment, when it has been determined in the determination of a correlation between the test fatigue life N_{lab} and the ramp rate during a falling low temperature RampDown_{lab} that there is a correlation, a linear function representing a normalized test fatigue life N_{lab} using a normalized ramp rate during a falling low temperature RampDown_{lab} is derived from a function representing the test fatigue life N_{lab} using the ramp rate during a falling low temperature RampDown_{lab}, m_{1b} is determined for [RampDown_{field}/RampDown_{lab}]^{m1b} constituting another portion of the ramp rate term [Ramp_{field}/Ramp_{lab}]^{m1} from the slope of the linear function, and [RampDown_{field}/RampDown_{lab}]^{m1b} is calculated.

In an embodiment, the step for calculating the acceleration factor AF further includes, when determining the exponent m₂ for the term of the dwell times Dwell_{field} and Dwell_{lab}, determining whether or not a dwell time Dwell_High_{lab} and a dwell time Dwell_Low_{lab} for a high temperature and a low temperature in the laboratory environment for the dwell time Dwell_{lab} are the same or different.

In an embodiment, when it has been determined that the dwell time Dwell_High_{lab} and the dwell time Dwell_Low_{lab} for a high temperature and a low temperature in the laboratory environment are the same, a function is derived representing the test fatigue life N_{lab} using a dwell time Dwell_{lab} corresponding to the Dwell_High_{lab} or the Dwell_Low_{lab} for a high temperature or a low temperature, and a correlation is derived between the test fatigue life N_{lab} and the dwell time Dwell_{lab}.

In an embodiment, when it has been determined in the determination of a correlation between the test fatigue life N_{lab} and the dwell time Dwell_{lab} that there is no correlation, m₂=0 and the dwell time term [Dwell_{field}/Dwell_{lab}]^{m2}=1.

In an embodiment, when it has been determined in the determination of a correlation between the test fatigue life N_{lab} and the dwell time Dwell_{lab} that there is a correlation, a linear function representing a normalized test fatigue life N_{lab} using a normalized dwell rate Dwell_{lab} is derived from the function representing the test fatigue life N_{lab} using the dwell time Dwell_{lab}, m₂ is determined from the slope of the linear function, and the dwell time term [Dwell_{field}/Dwell_{lab}]^{m2} is calculated.

In an embodiment, when it has been determined that the dwell times Dwell_High_{lab} and the Dwell_Low_{lab} for a high temperature and a low temperature in the laboratory environment are different, a function is derived representing the test fatigue life N_{lab} using the dwell time Dwell_High_{lab} for a high temperature and the correlation is determined between the test fatigue life N_{lab} and the dwell time Dwell_High_{lab} for a high temperature, and a function is derived representing the test fatigue life N_{lab} using the dwell time Dwell_Low_{lab} for a low temperature and a correlation is determined between the test fatigue life N_{lab} and the dwell time Dwell_Low_{lab} for a low temperature.

In an embodiment, when it has been determined in the determination of a correlation between the test fatigue life N_{lab} and the dwell time at high temperature Dwell_High_{lab} that there is no correlation, m₂a=0 and [Dwell_High_{field}/Dwell_High_{lab}]^{m2a}=1 for [Dwell_High_{field}/Dwell_High_{lab}]^{m2a} constituting a portion of the dwell time term [Dwell_{field}/Dwell_{lab}]^{m2}.

In an embodiment, when it has been determined in the determination of a correlation between the test fatigue life N_{lab} and the dwell time at high temperature Dwell_High_{lab} that there is a correlation, a linear function representing a normalized test fatigue life N_{lab} using a normalized dwell time at a high temperature Dwell_High_{lab} is derived from the function representing the test fatigue life N_{lab} using the dwell time at a high temperature Dwell_High_{lab}, m₂a is determined for [Dwell_High_{field}/Dwell_High_{lab}]^{m2a} constituting a portion of the dwell time term [Dwell_{field}/Dwell_{lab}]^{m2} from the slope of the linear function, and [Dwell_High_{field}/Dwell_High_{lab}]^{m2a} is calculated.

In an embodiment, when it has been determined in the determination of a correlation between the test fatigue life N_{lab} and the dwell time at low temperature Dwell_Low_{lab} that there is no correlation, m₂b=0 and [Dwell_Low_{field}/Dwell_Low_{lab}]^{m2b}=1 for [Dwell_Low_{field}/Dwell_Low_{lab}]^{m2b} constituting a portion of the dwell time term [Dwell_{field}/Dwell_{lab}]^{m2}.

In an embodiment, when it has been determined in the determination of a correlation between the test fatigue life N_{lab} and the dwell time at low temperature Dwell_Low_{lab} that there is a correlation, a linear function representing a normalized test fatigue life N_{lab} using a normalized dwell time at a low temperature Dwell_Low_{lab} is derived from the function representing the test fatigue life N_{lab} using the dwell time at a low temperature Dwell_Low_{lab}, m₂b is determined for [Dwell_Low_{field}/Dwell_Low_{lab}]^{m2b}, constituting another portion of the dwell time term [Dwell_{field}/Dwell_{lab}]^{m2b} from the slope of the linear function, and [Dwell_Low_{field}/Dwell_Low_{lab}]^{m2b} is calculated.

A further aspect of the present invention is a method for predicting the fatigue life of a solder joint in a product joined by soldering, the method comprising the steps of: establishing a maximum temperature Tₘₐₓ_{_{—}}_{field}, a minimum temperature Tₘᵢₙ_{_{—}}_{field}, and a temperature cycle frequency F_{field} in a field environment of the product; establishing a maximum temperature Tₘₐₓ_{_{—}}_{lab}, a minimum temperature Tₘᵢₙ_{_{—}}_{lab}, and a temperature cycle frequency F_{lab} in a laboratory environment for accelerated testing of the product; implementing the accelerated testing of the product to measure a test fatigue life N_{lab} until failure of the product; determining exponent m₁ for the ramp rate, exponent m₂ for the dwell time, and exponent m₂ for the minimum temperature in Equation 3 below, which is represented using the ramp rate Ramp_{field} and the dwell time Dwell_{field} of the field environment, and the ramp rate Ramp_{lab} and the dwell time Dwell_{lab} of the laboratory environment from the profile data of a temperature cycle using the established maximum temperature Tₘₐₓ_{_{—}}_{field}, the minimum temperature Tₘᵢₙ_{_{—}}_{field}, and the temperature cycle frequency F_{field} of the field environment, from the profile data of a temperature cycle using the established maximum temperature Tₘₐₓ _{_{—}}_{lab}, the minimum temperature Tₘᵢₙ_{_{—}}_{lab}, and the temperature cycle frequency F_{lab} of the laboratory environment, and from the measured data of the test fatigue life N_{lab}, and calculating an acceleration factor AF by plugging the determined exponents m₁, m₂ and m₃ into Equation 3; and calculating a field fatigue life N_{field} of the product from the calculated acceleration factor AF and the test fatigue life N_{lab} (N_{field}=AF×N_{lab}).

$$\begin{matrix} Equation 3 & \\ AF = {( \frac{Δ {T}_{field}}{Δ {T}_{lab}} )}^{- n} \times {( \frac{{Ramp}_{field}}{{Ramp}_{lab}} )}^{{m}_{1}} \times {( \frac{{Dwell}_{field}}{{Dwell}_{lab}} )}^{{m}_{2}} \times {( \frac{{Tmin}_{field}}{{Tmin}_{lab}} )}^{{m}_{3}} \times {e}^{\frac{{E}_{a}}{R} ( \frac{1}{{T}_{max\_field}} - \frac{1}{{T}_{max\_lab}} )} & ( Equation 3 )\end{matrix}$$

ΔT_{field}=Tₘₐₓ_{_{—}}_{field}−Tₘᵢₙ_{_{—}}_{field}

ΔT_{lab}=Tₘₐₓ_{_{—}}_{lab}−Tₘᵢₙ_{_{—}}_{lab}

### n: Constant Determined By Solder

### Eₐ: Activation Energy

### R: Boltzmann Constant

### BRIEF DESCRIPTION OF THE DRAWINGS

FIG. 1 is a graph showing profiles of temperature cycles at two different frequencies.

FIG. 2 is a flowchart schematically illustrating a method for predicting a solder joint fatigue life according to an embodiment of the present invention.

FIG. 3 is a flowchart showing processing performed in Step 240 of the method shown in FIG. 2.

FIG. 4 is a graph showing profiles of temperature cycles related to ramp rate.

FIG. 5 is a graph showing profiles of temperature cycles related to dwell time.

FIG. 6 is a graph showing a function representing test fatigue life using a ramp rate.

FIG. 7 is a graph showing a linear function representing normalized test fatigue life using a normalized ramp rate.

FIG. 8 is a graph showing a function representing test fatigue life using a dwell time.

FIG. 9 is a graph showing a linear function representing normalized test fatigue life using a normalized dwell time.

### DETAILED DESCRIPTION

### Technical Problems

In the commonly used Modified Coffin-Manson Equation, the acceleration factor AF is a function of the temperature cycle frequency F. Because of the relationship to the temperature cycle frequency F_{lab} for a laboratory environment in the denominator, m is ⅓ and a positive value. Thus, the value for the acceleration factor AF is smaller at a faster temperature cycle with a greater F_{lab} value, and the value for the acceleration factor AF is larger at a slower temperature cycle with a smaller F_{lab} value relative to a longer fatigue life. Therefore, the fatigue life is shorter.

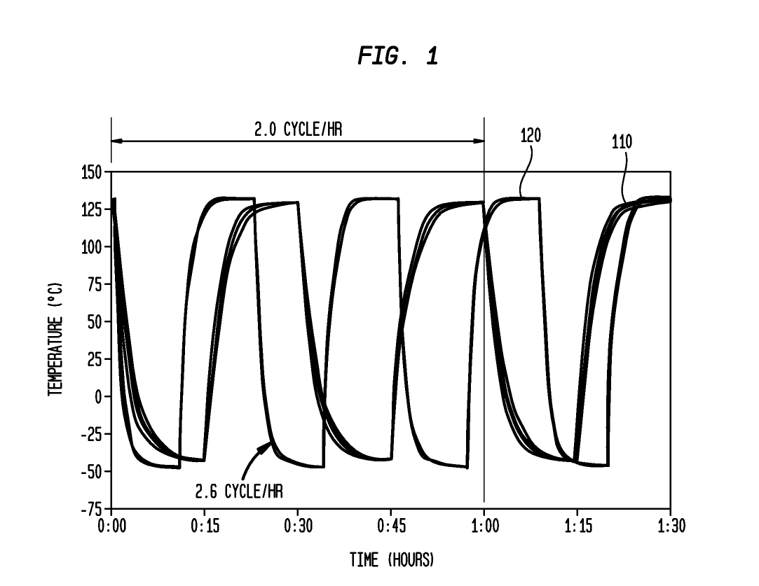

However, an experiment was conducted in which the oven conditions were JEDEC JESD 22-A104 Condition G (−45/125° C.) as shown in FIG. 1. In other words, the Tₘᵢₙ (minimum temperature) was −45° C., the Tₘₐₓ (maximum temperature) was 125° C., and SoakMode2 was used. Under these conditions, the temperature cycle frequencies are 2 cycles per hour (see 110 in FIG. 1) and 2.6 cycles per hour (see 120 in FIG. 1), with the holding time at Tₘᵢₙ and Tₘₐₓ being a minimum of five minutes. As a result, the fatigue life was 20% faster, that is, shorter, at 2.6 cycles per hour, which is the slower temperature cycle frequency. In the calculation performed using the Modified Coffin-Manson Equation, 2 cycles per hour, which is the faster temperature cycle frequency, had a larger acceleration factor AF than 2.6 cycles per hour, which is the slower temperature cycle frequency, and the fatigue life was 9% shorter. Thus, the experimental results demonstrated that the fatigue life prediction for the solder joint of the product using the Modified Coffin-Manson Equation was not accurate.

The acceleration factor modeled and calculated in the finite element analysis is in harmony with actual experimental results, but a model has to be created in the finite element analysis simulation for each product shape to be tested. The results depend entirely on the equation representing the model, how the model is created, the boundary conditions, and the incorporated parameters. In other words, it is not generalized, and a simple fatigue life prediction method cannot be obtained. A solder joint fatigue life prediction method using the crack growth rate of the solder joint is also not a simple fatigue life prediction method because the crack growth rates have to be determined and used individually.

The present invention realizes a simple method that is able to predict the fatigue life of a solder joint in a product.

### Solution to Problems

The following is an explanation of the present invention with reference to a preferred embodiment of the present invention. However, the present embodiment does not limit the present invention in the scope of the claims. Also, all combinations of characteristics explained in the embodiment are not necessarily required in the technical solution of the present invention. The present invention can be embodied in many different ways, and the present invention should not be interpreted as being limited to the content of the embodiment described below. In the explanation of the embodiment of the present invention, identical configurational units and configurational elements are denoted using the same reference signs.

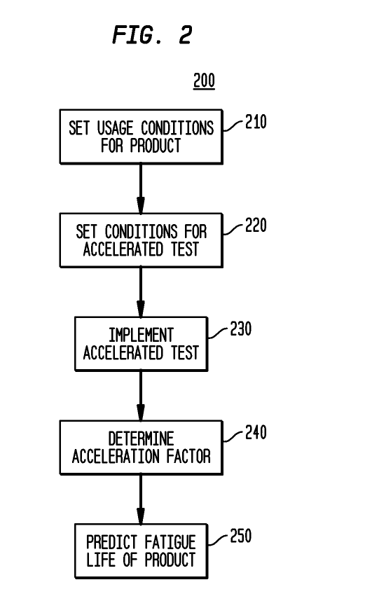

FIG. 2 is a flowchart schematically illustrating a method 200 for predicting a solder joint fatigue life according to an embodiment of the present invention. First, the field conditions of the solder-joined product are established (Step 210). The field conditions of the product include the maximum temperature Tₘₐₓ_{_{—}}_{field}, the minimum temperature Tₘᵢₙ_{_{—}}_{field}, and the temperature cycle frequency F_{field} under the field conditions of the product. These can be established by simply using the specifications of the product when available. At a minimum, the following items are usually provided in the specifications of a product.
Number of Years Under Product Warranty
Power ON Time (Power ON Time Guarantee)
ON/OFF Cycle (Number of Product ON/OFF Cycles)
Minimum/Maximum Operating Environment Temperatures (Installation Environment of the Product)
Minimum/Maximum Product Temperatures
Maximum Power of Product
Air Flow Rate During Cooling

Next, the conditions for the accelerated testing are established (Step 220).

The conditions for the accelerated testing include the maximum temperature Tₘₐₓ_{_{—}}_{lab}, the minimum temperature Tₘᵢₙ_{_{—}}_{lab}, and the temperature cycle frequency F_{lab} in the laboratory environment for accelerated testing of the product. For example, the accelerated testing can be performed under the JEDEC JESD 22-A104 Condition G (−45/125° C.) as shown in FIG. 1. In other words, the Tₘᵢₙ (minimum temperature) is −45° C., the Tₘₐₓ (maximum temperature) is 125° C., and SoakMode2 is used. Under these conditions, the temperature cycle frequencies are 2 cycles per hour (see 110 in FIG. 1) and 2.6 cycles per hour (see 120 in FIG. 1), with the dwell time (holding time) at Tₘᵢₙ and Tₘₐₓ being a minimum of five minutes. Thus, the maximum temperature Tₘₐₓ_{_{—}}_{lab} is established at 125° C., the minimum temperature Tₘᵢₙ_{_{—}}_{lab} is established at −45° C., and the temperature cycle frequencies F_{lab} are established at 2 cycles per hour and 2.6 cycles per hour.

Next, the accelerated testing is implemented under the established conditions (Step 230). The accelerated testing is implemented, and the test fatigue life N_{lab} is measured until failure of the product. If the test fatigue life N_{lab} can be measured in the accelerated testing by accelerating the failure of the product using the temperature load of the temperature cycle, an actual experiment does not have to be conducted. An experiment simulation able to faithfully reproduce an experiment can be employed.

Next, the acceleration factor is determined using a novel acceleration factor equation (Step 240). The novel acceleration factor equation can be either Equation 2 or Equation 3. An acceleration factor can be determined using either Equation 2 or Equation 3.

$$\begin{matrix} Equation 2 & \\ AF = {( \frac{Δ {T}_{field}}{Δ {T}_{lab}} )}^{- n} \times {( \frac{{Ramp}_{field}}{{Ramp}_{lab}} )}^{{m}_{1}} \times {( \frac{{Dwell}_{field}}{{Dwell}_{lab}} )}^{{m}_{2}} \times {e}^{\frac{{E}_{a}}{R} ( \frac{1}{{T}_{max\_field}} - \frac{1}{{T}_{max\_lab}} )} & ( Equation 2 )\end{matrix}$$

As for Equation 2, exponent m₁ for the ramp rate term [Ramp_{field}/Ramp_{lab}]^{m1} and exponent m₂ for the dwell time term [Dwell_{field}/Dwell_{lab}]^{m2}, which are represented using the ramp rate Ramp_{field} and the dwell time Dwell_{field} of the field environment, and the ramp rate Ramp_{lab} and the dwell time Dwell_{lab} of the laboratory environment, are determined from the profile data of the temperature cycle using the established maximum temperature Tₘₐₓ_{_{—}}_{field}, the minimum temperature Tₘᵢₙ_{_{—}}_{field}, and the temperature cycle frequency F_{field} of the field environment established in Step 210, from the profile data of the temperature cycle using the established maximum temperature Tₘₐₓ_{_{—}}_{lab}, of minimum temperature Tₘᵢₙ_{_{—}}_{lab}, and the temperature cycle frequency F_{lab} of the laboratory environment established in Step 220, and from the test fatigue life N_{lab} measured in Step 230, and the acceleration factor AF is calculated by plugging the determined exponents m₁ and m₂ into Equation 2.

$$\begin{matrix} Equation 3 & \\ AF = {( \frac{Δ {T}_{field}}{Δ {T}_{lab}} )}^{- n} \times {( \frac{{Ramp}_{field}}{{Ramp}_{lab}} )}^{{m}_{1}} \times {( \frac{{Dwell}_{field}}{{Dwell}_{lab}} )}^{{m}_{2}} \times {( \frac{{Tmin}_{field}}{{Tmin}_{lab}} )}^{{m}_{3}} \times {e}^{\frac{{E}_{a}}{R} ( \frac{1}{{T}_{max\_field}} - \frac{1}{{T}_{max\_lab}} )} & ( Equation 3 )\end{matrix}$$

As for Equation 3, exponent m₁ for the ramp rate term [Ramp_{field}/Ramp_{lab}]^{m1}, exponent m₂ for the dwell time term [Dwell_{field}/Dwell_{lab}]^{m2}, and exponent m₃ for the minimum temperature term [Tₘᵢₙ_{_{—}}_{field}/Tₘᵢₙ_{_{—}}_{lab}]^{m3}, which are represented using the ramp rate Ramp_{field}, the dwell time Dwell_{field}, and the minimum temperature Tₘᵢₙ_{_{—}}_{field} of the field environment, and the ramp rate Ramp_{lab}, the dwell time Dwell_{lab}, and the minimum temperature Tₘᵢₙ_{_{—}}_{lab} of the laboratory environment, are determined from the profile data of the temperature cycle using the established maximum temperature Tₘₐₓ_{_{—}}_{field}, the minimum temperature Tₘᵢₙ_{_{—}}_{field}, and the temperature cycle frequency F_{field} of the field environment established in Step 210, from the profile data of the temperature cycle using the established maximum temperature Tₘₐₓ _{_{—}}_{lab}, the minimum temperature Tₘᵢₙ_{_{—}}_{lab}, and the temperature cycle frequency F_{lab} of the laboratory environment established in Step 220, and from the measured data of the test fatigue life N_{lab} established in Step 230, and an acceleration factor AF is calculated by plugging the determined exponents m₁, m₂ and m₃ into Equation 3.

Next, the fatigue life of the product is estimated (Step 250). The fatigue life of the product is estimated by calculating the field fatigue life N_{field} of the product from the acceleration factor AF calculated using Equation 2 or Equation 3, and from the measured test fatigue life N_{lab} (N_{field}=AF×N_{lab}) The fatigue life of the solder joint estimated in this way does not depend on the temperature cycle frequency as in the Modified Coffin-Manson Equation, but is derived in a newly devised way from the ramp rate and the dwell time or from the ramp rate, the dwell time and the minimum temperature. As a result, the fatigue life is more accurately reflected in accelerated testing, and matches experimental results more closely than the Modified Coffin-Manson Equation.

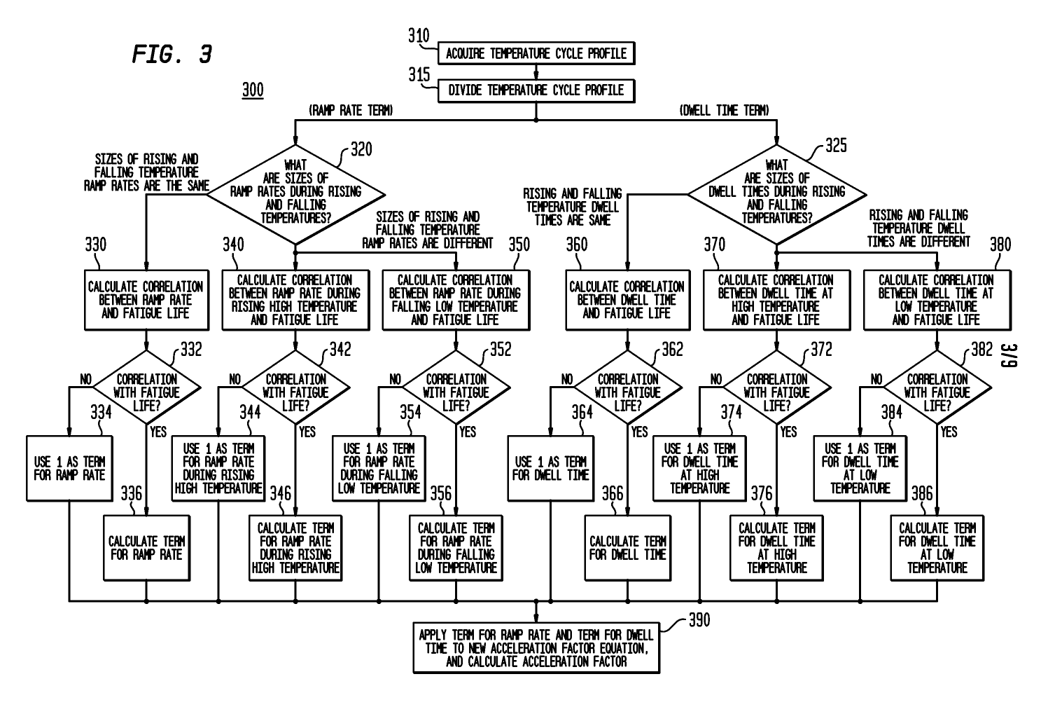

FIG. 3 is a flowchart showing processing 300 performed in Step 240 of the method 200. First, the temperature cycle profiles are acquired (Step 310). The temperature cycle profiles, which represent the relationship between temperature and time, include the temperature cycle profile for the field environment and the temperature cycle profile for the laboratory environment. The temperature cycle profile data for the field environment is obtained from the maximum temperature Tₘₐₓ_{_{—}}_{field}, minimum temperature Tₘᵢₙ_{_{—}}_{field}, and the temperature cycle frequency F_{field}, and the temperature cycle profile data for the laboratory environment is obtained from the maximum temperature Tₘₐₓ_{_{—}}_{lab}, minimum temperature Tₘᵢₙ_{_{—}}_{lab}, and the temperature cycle frequency F_{lab}.

A temperature cycle profile for the field environment can be obtained from the data in the following way. When there are 3,000 ON/OFF cycles over 40,000 hours, the power ON time is calculated as 40,000/3,000≈13.3 hours/cycle, and the time per cycle is 13.3 hours. When the rising temperature and falling temperature times are 30 minutes each and the retention time at the high temperature and the low temperature are the same based on the characteristics of the product and its application, the dwell time for the field environment is Dwell_High_{field}=Dwell_Low_{field}=Dwell_{field}, or Dwell_{field}=[(40000/3000)−(0.5*2)]/2≈6.17 hours. When the minimum temperature Tₘᵢₙ_{_{—}}_{field} and the maximum temperature Tₘₐₓ_{_{—}}_{field} for the field environment of the product are −10° C. and 105° C., and the sizes of the ramp rates RampUp_{field} and RampDown_{field} during rising and falling temperatures are the same, the ramp rate for the field environment is RampUp_{field}=RampDown_{field}=Ramp_{field}, or Ramp_{field}=[105−(−10)]/30≈3.83° C./minute. In this way, the dwell times Dwell_High_{field} and Dwell_Low_{field} and the ramp rates RampUp_{field} and RampDown_{field} for the field environment can be obtained whether the high-temperature and low-temperature dwell times and the rising temperature and falling temperature ramp rates are the same or different.

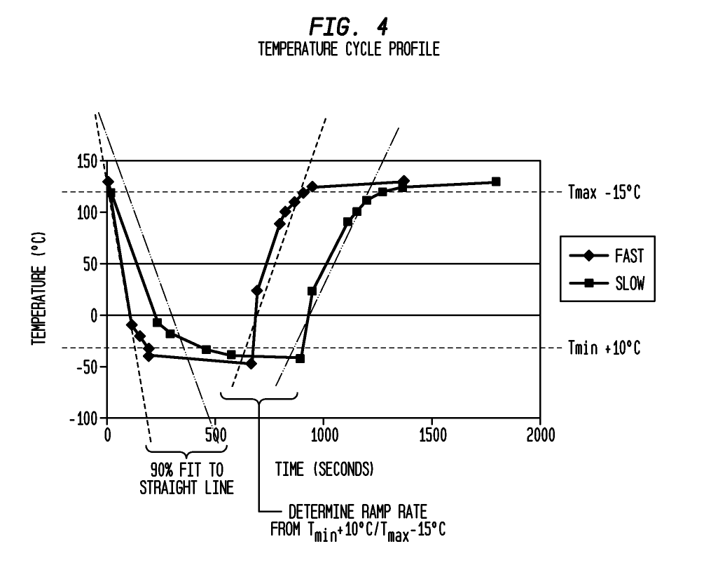

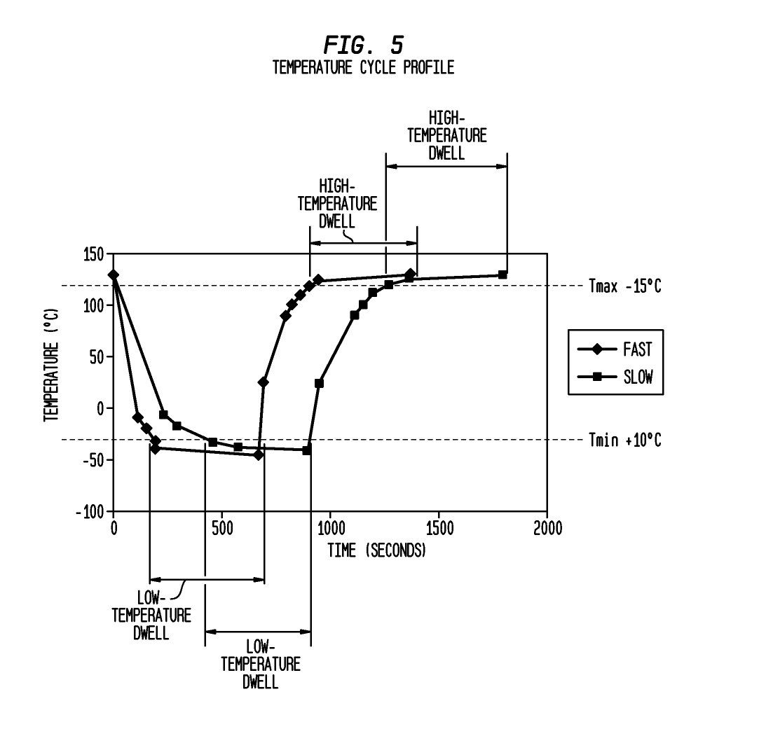

A temperature cycle profile for the laboratory environment can be obtained from the data in the following way. In FIG. 4 and FIG. 5, a temperature cycle profile for the laboratory environment is represented in a graph using temperature and time data. The graphs in FIG. 4 and FIG. 5 represent the relationship between temperature and time by linking the temperature (° C.) and the time (seconds) when the temperature cycle frequency is 2.6 cycles/hour (FAST) and when the temperature cycle frequency is 2 cycles/hour (SLOW). A single temperature cycle is shown in FIG. 4 and FIG. 5, but a single cycle is enough to determine the temperature cycle profile because the same cycle is repeated. FIG. 4 and FIG. 5 show examples of temperature cycle profile data for two different temperature cycles, but the temperature cycle profile data can also be determined using a single temperature cycle frequency. When determined using a single temperature cycle frequency, various temperature cycle profiles can be obtained by varying the ramp rate and dwell time.

Next, the temperature cycle profile is divided (Step 315), and the ramp rate term and the dwell time term are processed. Because the ramp rates and dwell times for the field environment have already been explained, the ramp rates and dwell times for the laboratory environment will now be explained. The ramp rates for the laboratory environment include the rising temperature and falling temperature ramp rates RampUp_{lab} and RampDown_{lab} in the temperature cycle. The ramp rates for the laboratory environment can be determined from the temperature rate (unit: ° C./hour) for the portion of the relationship of the temperature and the time when the temperature is rising or falling which is a 90% fit with a straight line, or from the temperature rate (unit: ° C./hour) for a rising or falling temperature between the maximum temperature Tₘₐₓ_{_{—lab}}−15° C. and the minimum temperature Tₘᵢₙ_{_{—}}_{lab}+10° C. In FIG. 4, the falling temperature ramp rate RampDown_{lab} is determined from the temperature rate (unit: ° C./hour) for the portion which is a 90% fit with a straight line, and the rising temperature ramp rate RampUp_{lab} is determined from the temperature rate (unit: ° C./hour) between the maximum temperature Tₘₐₓ _{_{—}}_{lab}−15° C. and the minimum temperature Tₘᵢₙ_{_{—}}_{lab}+10° C.

The dwell times for the laboratory environment include high-temperature and low-temperature dwell times Dwell_High_{lab} and Dwell_Low_{lab}. In dwell times for the laboratory environment, the high-temperature dwell time Dwell_High_{lab} can be the time the temperature is held between the maximum temperature Tₘₐₓ_{_{—}}_{lab} and the maximum temperature Tₘₐₓ_{_{—}}_{lab}−15° C., and the low-temperature dwell time Dwell_Low_{lab} can be the time the temperature is held between the minimum temperature Tₘᵢₙ_{_{—}}_{lab} and the minimum temperature Tₘₐₓ_{_{—}}_{lab}+10° C. For example, when the maximum temperature Tₘₐₓ_{_{—}}_{lab} is 125° C., the high-temperature dwell time Dwell_High_{lab} is the time the product is held at a temperature between 110° C. (125-15° C.) and 125° C. When the minimum temperature Tₘᵢₙ_{_{—}}_{lab} is −45° C., the low-temperature dwell time Dwell_Low_{lab} is the time the product is held at a temperature between −35° C. (−45+10° C.) and −45° C. As shown in FIG. 5, the high-temperature and low-temperature dwell times Dwell_High_{lab} and Dwell_Low_{lab} are determined from the temperature cycle profiles.

When the ramp rate term shown on the left in FIG. 3 is processed, it is first determined whether the sizes of the rising temperature and falling temperature ramp rates RampUp_{lab} and RampDown_{lab} are the same or different (Step 320). In this determination, it is determined whether the sizes of these ramp rates RampUp_{lab} and RampDown_{lab} are different by 20% or more. If not, they are deemed to be the same. The faster or larger ramp rate is used as the reference, and it is determined by comparing 20% of the size to the difference between the sizes of both ramp rates.

Next, when it has been determined that the sizes of the rising temperature and falling temperature ramp rates RampUp_{lab} and RampDown_{lab} are the same, the process advances to Step 330, and the correlation between the ramp rate and the fatigue life is calculated. In this calculation, the temperature cycle profile data is used to derive a function representing the test fatigue life N_{lab} using at least three different ramp rates for at least three different dwell times. For example, the three different dwell times may be the same at the high-temperature end, the low-temperature end, or both ends, and may be 5 minutes, 10 minutes and 20 minutes. The three different ramp rates at these dwell times may be the same for a rising temperature, a falling temperature, or both. These may be 82.5° C./minute, 16.5° C./minute and 6.6° C./minute during a rising temperature. The results shown in Table 1 below were obtained when nine different combinations of these dwell times and ramp rates were applied to fatigue life N(50) at which 50% of the products in the accelerated testing failed. A fatigue life N(50) at which 50% of the products in the accelerated testing fail is used as the test fatigue life N_{lab} so as to take into account the implementation time of the accelerated testing. However, the test fatigue life N_{lab} is not limited to fatigue life N(50). If the implementation time of the accelerated testing is not taken into account, any fatigue life N(P) at which 50% or more of the products in the accelerated testing fail can be used. Here, 50≦P≦100 because 50% or more of the products have to fail in the accelerated testing in order to obtain a test fatigue life N_{lab} that is reliable and accurate.

TABLE 1
N(50) Fatigue Life

| | | Dwell Time (Minutes) | | |
|---|---|---|---|---|
| | | 5 | 10 | 20 |
| Rising | 82.5 | 2389 | 2345 | 2308 |
| Ramp Rate | 16.5 | 2722 | 2677 | 2637 |
| (° C./min.) | 6.6 | 2926 | 2880 | 2837 |

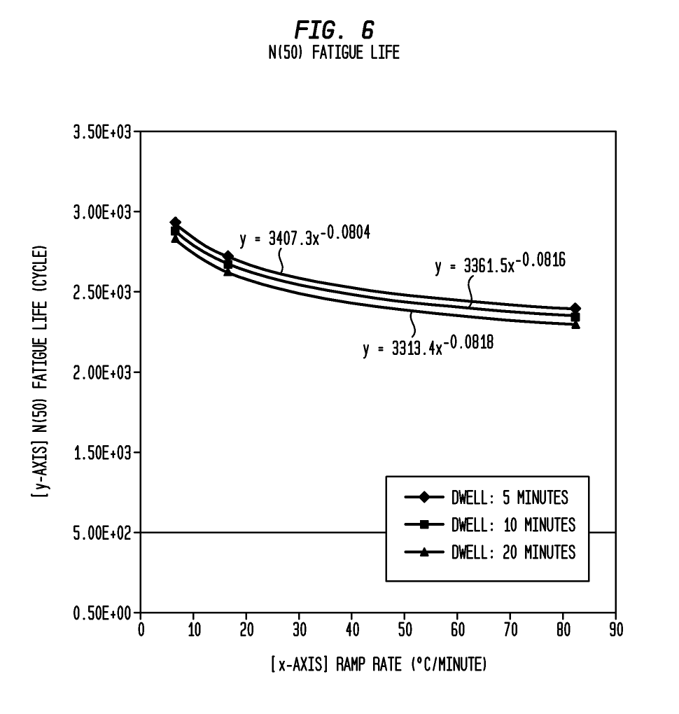

The functions shown in FIG. 6 were derived by plotting the data in Table 1 on a graph in which the vertical axis denotes the fatigue life N(50) and the horizontal axis denotes the ramp rate. As shown in FIG. 6, the fatigue life N(50) becomes smaller or shorter as the ramp rate becomes faster or larger.

Next, the correlation with fatigue life is determined (Step 332). In this determination, the derived functions are used. As shown in FIG. 6, the three derived functions are similar, and indicate the correlation between fatigue life and ramp rate. If the three derived functions are different or the ramp rates do not change the fatigue life N(50) by more than 5% in the entire ramp rate range, it can be determined that there is no correlation between fatigue life and ramp rate. In this situation, the process advances to Step 334, where m₁=0 for the ramp rate term [Ramp_{field}/Ramp_{lab}]^{m1} in Equation 2 or Equation 3, and [Ramp_{field}/Ramp_{lab}]^{m1}=1. Afterwards, the process advances to Step 390, and [Ramp_{field}/Ramp_{lab}]^{m1}=1 is used in the novel acceleration function equation of Equation 2 or Equation 3.

When it has been determined in Step 332 that there is a correlation between the fatigue life and the ramp rate, the process advances to Step 336 where the ramp rate term is calculated. In the calculation of the ramp rate term, a linear function representing a normalized fatigue life N(50) using a normalized ramp rate is derived from a function representing the three fatigue lives N(50) derived in Step 330 (in the calculation of the correlation between the ramp rate and the fatigue life) using the ramp rate. In this derivation, the logarithms of the data in Table 1 are taken, and the values shown in Table 2 below are used.

TABLE 2
Normalized N(50) Fatigue Life

| | | Dwell Time | | |
|---|---|---|---|---|
| | | 0.69897 | 1 | 1.30103 |
| Rising | 1.916454 | 3.378245 | 3.370086 | 3.363315 |
| Ramp | 1.217484 | 3.434904 | 3.427662 | 3.421146 |
| Rate | 0.819544 | 3.466319 | 3.45943 | 3.452926 |

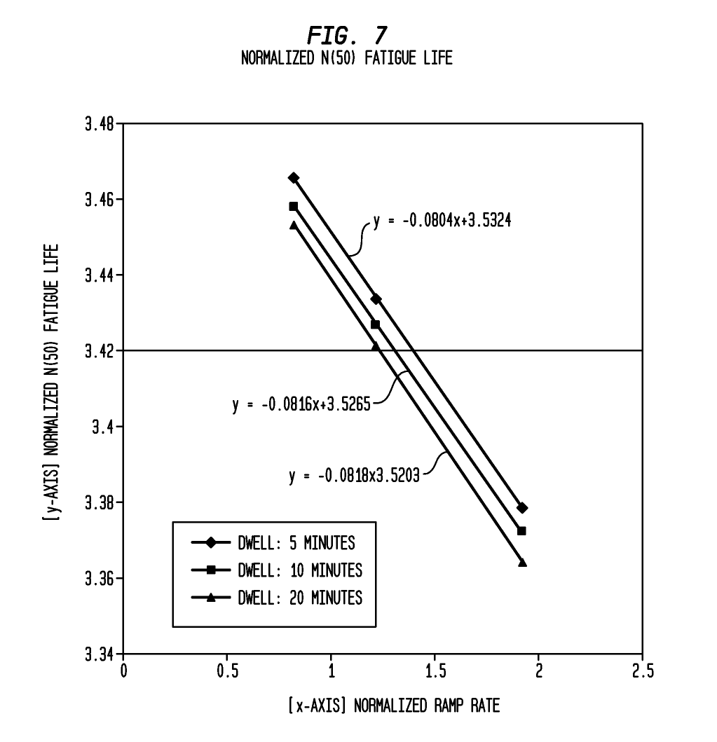

When numerical values in Table 2 are graphed with the vertical axis denoting the normalized fatigue life N(50) and the horizontal axis denoting the normalized ramp rate, the linear functions shown in FIG. 7 are derived. The resulting slopes of the three linear functions are a coefficient of variable x. The average of the three slopes is taken as the slope of the linear function. Because the ramp rate is RampUp_{lab}=RampDown_{lab}=Ramp_{lab}, m₁ is obtained from the resulting slope, and the ramp rate term [Ramp_{field}/Ramp_{lab}]^{m1} is calculated. A value obtained in the manner described above is used as Ramp_{field}, and a value obtained in the accelerated testing is used as Ramp_{lab}. Afterwards, the process advances to Step 390, and the calculated ramp rate term [Ramp_{field}/Ramp_{lab}]^{m1} is plugged into the novel acceleration factor equation in Equation 2 or Equation 3.

When it has been determined in Step 320 that the sizes of the rising temperature and falling temperature ramp rates are different, the process advances to Step 340 or Step 350. In Step 340, the correlation between the ramp rate and the fatigue life during high-temperature rising is calculated. In Step 350, the correlation between the ramp rate and the fatigue life during low-temperature falling is calculated. These calculations are performed in the same way as the calculations in Step 330. However, the data for the ramp rate is data for the ramp rate during high-temperature rising or data for the ramp rate during low-temperature falling. Data is obtained as shown in Table 1, and as shown in FIG. 6, functions are derived representing the fatigue life N(50) using the ramp rate during high-temperature rising or the ramp rate during low-temperature falling.

Next, the correlations with the fatigue life are determined (Step 342 and Step 352). These determinations are performed in the same way as the determination in Step 332. If the three functions derived in Step 340 or Step 350 are similar, the correlation with the fatigue life can be determined. If the three derived functions are different or the ramp rates do not change the fatigue life N(50) by more than 5% in the entire ramp rate range, it can be determined that there is no correlation between fatigue life and ramp rate. In this situation, the process advances to Step 344 and Step 354, where m₁ₐ=0 for [RampUp_{field}/RampUp_{lab}]^{m1a}, which is a portion of ramp rate term [Ramp_{field}/Ramp_{lab}]^{m1} in Equation 2 or Equation 3, and [RampUp_{field}/RampUp_{lab}]^{m1a}=1. Alternatively, m_{1b}=0 for [RampDown_{field}/RampDown_{lab}]^{m1b}, which is a portion of ramp rate term [Ramp_{field}/Ramp_{lab}]^{m1} in Equation 2 or Equation 3, and [RampDown_{field}/RampDown_{lab}]^{m1b}=1. Afterwards, the process advances to Step 390, and [RampUp_{field}/RampUp_{lab}]^{m1a}=1 or [RampDown_{field}/RampDown_{lab}]^{m1b}=1 is used in the novel acceleration function equation of Equation 2 or Equation 3.

When it has been determined in Step 342 that there is a correlation between the fatigue life and the high-temperature rising ramp rate, the process advances to Step 346 where the high-temperature rising ramp rate term is calculated. When it has been determined in Step 352 that there is a correlation between the fatigue life and the low-temperature falling ramp rate, the process advances to Step 356 where the low-temperature falling ramp rate term is calculated. The calculation for the high-temperature rising ramp rate term and the calculation for the low-temperature falling ramp rate term are performed in the same way as the calculation in Step 336. A linear function expressing a normalized fatigue life N(50) using a normalized high-temperature rising ramp rate is derived from a function representing the three fatigue lives N(50) derived in Step 340 (in the calculation of the correlation between the high-temperature rising ramp rate and the fatigue life) using the high-temperature rising ramp rate, determining, from the slope of the derived linear function, m₁ₐ for [RampUp_{field}/RampUp_{lab}]^{m1a}, which is one portion of the ramp rate term [Ramp_{field}/Ramp_{lab}]^{m1}, and [RampUp_{field}/RampUp_{lab}]^{m1a} is calculated. A value obtained in the manner described above is used for RampUp_{field}, and a value obtained in accelerated testing is used for RampUp_{lab}. A linear function expressing a normalized fatigue life N(50) using a normalized low-temperature falling ramp rate is derived from a function representing the three fatigue lives N(50) derived in Step 350 (in the calculation of the correlation between the low-temperature falling ramp rate and the fatigue life) using the low-temperature falling ramp rate, determining, from the slope of the derived linear function, m_{1b} for [RampDown_{field}/RampDown_{lab}]^{m1b}, which is one portion of the ramp rate term [Ramp_{field}/Ramp_{lab}]^{m1}, and [RampDown_{field}/RampDown_{lab}]^{m1b} is calculated. A value obtained in the manner described above is used for RampDown_{field}, and a value obtained in accelerated testing is used for RampDown_{lab}. Afterwards, the process advances to Step 390, and the calculated ramp rate term [RampUp_{field}/RampUp_{lab}]^{m1a} or [RampDown_{field}/RampDown_{lab}]^{m1b} is applied to the novel acceleration factor equation of Equation 2 or Equation 3.

When the dwell time term shown on the right in FIG. 3 is processed, it is first determined whether the high-temperature and low-temperature dwell times are the same or different (Step 325). In this determination, it is determined whether the dwell times Dwell_High_{lab} and Dwell_Low_{lab} are different by 20% or more. If not, they are deemed to be the same. The longer dwell time is used as the reference, and it is determined by comparing 20% of the longer time to the difference between both dwell times.

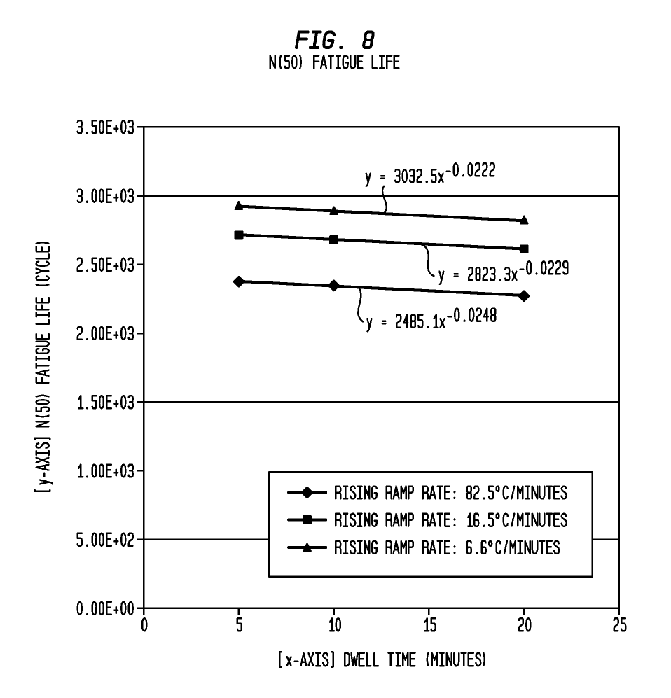

Next, when it has been determined that the high-temperature and low-temperature dwell times Dwell_High_{lab} and Dwell_Low_{lab} are the same, the process advances to Step 360, and the correlation between the dwell time and the fatigue life is calculated. In this calculation, the temperature cycle profile data is used to derive a function representing the test fatigue life N_{lab} using at least three different dwell times for at least three different ramp rates. For example, the three different ramp rates may be the same for a rising temperature, a falling temperature, or both. These may be 82.5° C./minute, 16.5° C./minute and 6.6° C./minute during a rising temperature. The three different dwell times at these ramp rates may be the same at the high-temperature end, the low-temperature end, or both ends, and may be 5 minutes, 10 minutes and 20 minutes. The results shown in Table 1 above were obtained when nine different combinations of these dwell times and ramp rates were applied to fatigue life N(50) at which 50% of the products in the accelerated testing failed. The functions shown in FIG. 8 are derived when the data in Table 1 is graphed with the vertical axis denoting the fatigue life N(50) and the horizontal axis denoting the dwell time.

Next, the correlation with fatigue life is determined (Step 362). In this determination, the derived functions are used. As shown in FIG. 8, the three derived functions are similar, and indicate the correlation between fatigue life and ramp rate. If the three derived functions are different or the dwell times do not change the fatigue life N(50) by more than 5% in the entire dwell time range, it can be determined that there is no correlation between fatigue life and dwell time. In this situation, the process advances to Step 364, where m₂=0 for the dwell time term [Dwell_{field}/Dwell_{lab}]^{m2} in Equation 2 or Equation 3, and [Dwell_{field}/Dwell_{lab}]^{m2}=1. Afterwards, the process advances to Step 390, and [Dwell_{field}-Dwell_{lab}]^{m2}=1 is used in the novel acceleration function equation of Equation 2 or Equation 3.

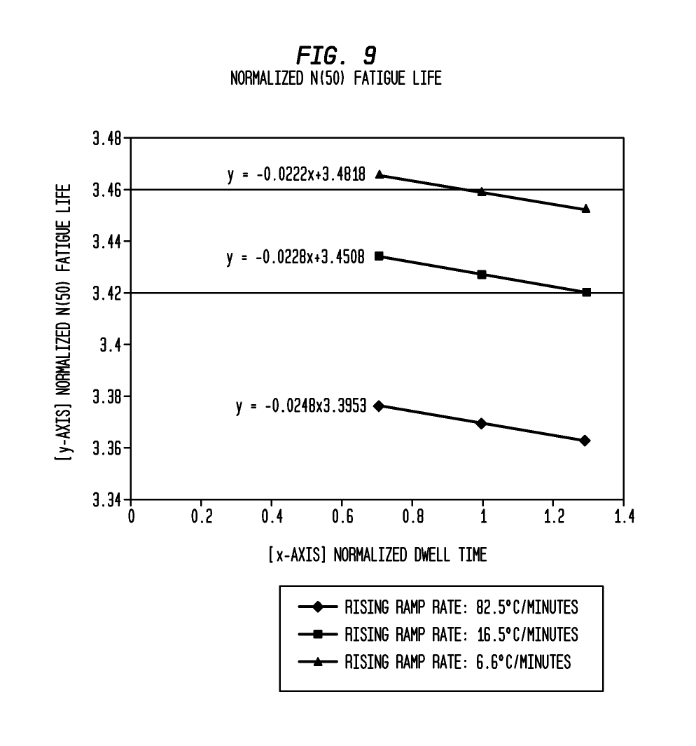

When it has been determined in Step 362 that there is a correlation between the fatigue life and the dwell time, the process advances to Step 366 where the dwell time term is calculated. In the calculation of the dwell time term, a linear function representing a normalized fatigue life N(50) using a normalized dwell time is derived from a function representing the three fatigue lives N(50) derived in Step 360 (in the calculation of the correlation between the dwell time and the fatigue life) using the dwell time. In this derivation, the logarithms of the data in Table 1 are taken, and the values shown in Table 2 below are used. When numerical values in Table 2 are graphed with the vertical axis denoting the normalized fatigue life N(50) and the horizontal axis denoting the normalized dwell time, the linear functions shown in FIG. 9 are derived. The resulting slopes of the three linear functions are a coefficient of variable x. The average of the three slopes is taken as the slope of the linear function. Because the dwell time is Dwell_High_{lab}=Dwell_Low_{lab}=Dwell_{lab}, m₂ is obtained from the resulting slope, and the dwell time term [Dwell_{field}/Dwell_{lab}]^{m2} is calculated. A value obtained in the manner described above is used as Dwell_{field}, and a value obtained in the accelerated testing is used as Dwell_{lab}. Afterwards, the process advances to Step 390, and the calculated dwell time term [Dwell_{field}/Dwell_{lab}]^{m2} is plugged into the novel acceleration factor equation in Equation 2 or Equation 3.

When it has been determined in Step 325 that the high-temperature and low-temperature dwell times are different, the process advances to Step 370 or Step 380. In Step 370, the correlation between the high-temperature dwell time and the fatigue life is calculated. In Step 380, the correlation between the low-temperature dwell time and the fatigue life is calculated. These calculations are performed in the same way as the calculations in Step 360. However, the data for the dwell time is data for the high-temperature dwell time or data for the low-temperature dwell time. Data is obtained as shown in Table 1, and as shown in FIG. 8, functions are derived representing the fatigue life N(50) using the high-temperature dwell time or the low-temperature dwell time.

Next, the correlations with the fatigue life are determined (Step 372 and Step 382). These determinations are performed in the same way as the determination in Step 362. If the three functions derived in Step 370 or Step 380 are similar, the correlation with the fatigue life can be determined. If the three derived functions are different or the dwell times do not change the fatigue life N(50) by more than 5% in the entire dwell time range, it can be determined that there is no correlation between fatigue life and dwell time. In this situation, the process advances to Step 374 and Step 384, where m₂a=0 for [Dwell_High_{field}/Dwell_High_{lab}]^{m2a}, which is a portion of dwell time term [Dwell_High_{field}/Dwell_High_{lab}]^{m2} in Equation 2 or Equation 3, and [Dwell_High_{field}/Dwell_High_{lab}]^{m2a}=1. Alternatively, m₂b=0 for [Dwell_Low_{field}/Dwell_Low_{lab}]^{m2b}, which is a portion of dwell time term [Dwell_{field}/Dwell_{lab}]^{m2} in Equation 2 or Equation 3, and [Dwell_Low_{field}/Dwell_Low_{lab}]^{m2b}=1. Afterwards, the process advances to Step 390, and [Dwell_High_{field}/Dwell_High_{lab}]^{m2a}=1 or [Dwell_Low_{filed}/Dwell_Low_{lab}]^{m2b}=1 is used in the novel acceleration function equation of Equation 2 or Equation 3.

When it has been determined in Step 372 that there is a correlation between the fatigue life and the high-temperature dwell time, the process advances to Step 376 where the high-temperature dwell time term is calculated. When it has been determined in Step 382 that there is a correlation between the fatigue life and the low-temperature dwell time, the process advances to Step 386 where the low-temperature dwell time term is calculated. The calculation for the high-temperature dwell time term and the calculation for the low-temperature dwell time term are performed in the same way as the calculation in Step 366. A linear function expressing a normalized fatigue life N(50) using a normalized high-temperature dwell time is derived from a function representing the three fatigue lives N(50) derived in Step 370 (in the calculation of the correlation between the high-temperature dwell time and the fatigue life) using the high-temperature dwell time, determining, from the slope of the derived linear function, m₂a for [Dwell_High_{field}/Dwell_High_{lab}]^{m2a}, which is one portion of the dwell time term [Dwell_{field}/Dwell_{lab}]^{m2}, and [Dwell_High_{field}/Dwell_High_{lab}]^{m2a} is calculated. A value obtained in the manner described above is used for Dwell_High_{field}, and a value obtained in accelerated testing is used for Dwell_High_{lab}. A linear function expressing a normalized fatigue life N(50) using a normalized low-temperature dwell time is derived from a function representing the three fatigue lives N(50) derived in Step 380 (in the calculation of the correlation between the low-temperature dwell time and the fatigue life) using the low-temperature dwell time, determining, from the slope of the derived linear function, m₂b for [Dwell_Low_{field}/Dwell_Low_{lab}]^{m2b}, which is one portion of the dwell time term [Dwell_{field}/Dwell_{lab}]^{m2}, and [Dwell_Low_{field}/Dwell_Low_{lab}]^{m2b} is calculated. A value obtained in the manner described above is used for Dwell_Low_{field}, and a value obtained in accelerated testing is used for Dwell_Low_{lab}. Afterwards, the process advances to Step 390, and the calculated dwell time term [Dwell_High_{field}/Dwell_High_{lab}]^{m2a} or [Dwell_Low_{field}/Dwell_Low_{lab}]^{m2b} is applied to the novel acceleration factor equation of Equation 2 or Equation 3.

Afterwards, in Step 390, the values of the ramp rate term and the dwell time term corresponding to the calculations are plugged into the novel acceleration factor equation of Equation 2 or Equation 3, and the acceleration factor AF is calculated. The product of the acceleration factor AF calculated in process 300 of FIG. 3 and the fatigue life N(50) is determined to calculate the field fatigue life of the product, and the fatigue life of the product is predicted as shown in Step 250 of FIG. 2.

A minimum temperature term [Tₘᵢₙ_{_{—}}_{field}/Tₘᵢₙ_{_{—}}_{lab}]^{m3} is included in the novel acceleration factor equation of Equation 3. The minimum temperature term is incorporated so as to take into account the effect of the minimum temperature on the fatigue life of a solder joint in the same manner as the ramp rate and dwell time. The value for the minimum temperature can be determined in the same way the values for the ramp rate term and the dwell time term were determined in FIG. 3.

The present invention was explained using an embodiment, but the technical scope of the present invention is not limited to the embodiment described above. Various changes and improvements can be added to the embodiment, and embodiments with these changes and improvements are included within the technical scope of the present invention.

What is claimed is:

1. A method for predicting the fatigue life of a solder joint in a product joined by soldering, the method comprising the steps of:
establishing a maximum temperature Tₘₐₓ_{_{—}}_{field}, a minimum temperature Tₘᵢₙ_{_{—}}_{field}, and a temperature cycle frequency F_{field} in a field environment of the product;
establishing a maximum temperature Tₘₐₓ_{_{—}}_{lab}, a minimum temperature Tₘᵢₙ_{_{—}}_{lab}, and a temperature cycle frequency F_{lab} in a laboratory environment for accelerated testing of the product;
implementing the accelerated testing of the product to measure a test fatigue life N_{lab} until failure of the product;
determining exponent m₁ for the ramp rate and exponent m₂ for the dwell time in Equation 1 below, which is represented using the ramp rate Ramp_{field} and the dwell time Dwell_{field} of the field environment, and the ramp rate Ramp_{lab} and the dwell time Dwell_{lab} of the laboratory environment from profile data of a temperature cycle using the established maximum temperature Tₘₐₓ_{_{—}}_{field}, the minimum temperature Tₘᵢₙ_{_{—}}_{field}, and the temperature cycle frequency F_{field} of the field environment, from profile data of a temperature cycle using the established maximum temperature Tₘₐₓ_{_{—}}_{lab}, the minimum temperature Tₘᵢₙ_{_{—}}_{lab}, and the temperature cycle frequency F_{lab} of the laboratory environment, and from measured data of the test fatigue life N_{lab}, and calculating an acceleration factor AF by plugging determined exponents m₁ and m₂ into Equation 1;
$$\begin{matrix} Equation 1 & \\ AF = {( \frac{Δ {T}_{field}}{Δ {T}_{lab}} )}^{- n} \times {( \frac{{Ramp}_{field}}{{Ramp}_{lab}} )}^{{m}_{1}} \times {( \frac{{Dwell}_{field}}{{Dwell}_{lab}} )}^{{m}_{2}} \times {e}^{\frac{{E}_{a}}{R} ( \frac{1}{{T}_{max\_field}} - \frac{1}{{T}_{max\_lab}} )} & ( Equation 1 )\end{matrix}$$
ΔT_{field}=Tₘₐₓ_{_{—}}_{field}−Tₘᵢₙ_{_{—}}_{field}
ΔT_{lab}=Tₘₐₓ_{_{—}}_{lab}−Tₘᵢₙ_{_{—}}_{lab}
n: Constant Determined By Solder
Eₐ: Activation Energy
R: Boltzmann Constant
and calculating a field fatigue life N_{field} of the product from the calculated acceleration factor AF and the test fatigue life N_{lab} (N_{field}=AF×N_{lab}).

2. The method of claim 1, wherein the step for calculating the acceleration factor AF further comprises, when determining the exponent m₁ for the term of the ramp rates Ramp_{field} and Ramp_{lab}, determining whether or not the size of a ramp rate RampUp_{lab} and a ramp rate RampDown_{lab} for a rising temperature and a falling temperature in the temperature cycle of the laboratory environment for the ramp rate Ramp_{lab} are the same or different.

3. The method of claim 2, further comprising, when it has been determined that the size of the ramp rate RampUp_{lab} and the ramp rate RampDown_{lab} for a rising temperature and a falling temperature in the temperature cycle of the laboratory environment are the same, deriving a function representing the test fatigue life N_{lab} using a ramp rate Ramp_{lab} corresponding to the ramp rate RampUp_{lab} or the ramp rate RampDown_{lab} for a rising or falling temperature, and determining a correlation between the test fatigue life N_{lab} and the ramp rate Ramp_{lab}.

4. The method of claim 3, wherein, when it has been determined in the determination of a correlation between the test fatigue life N_{lab} and the ramp rate Ramp_{lab} that there is no correlation, m₁=0, and the ramp rate term [Ramp_{field}/Ramp_{lab}]^{m1}=1.

5. The method of claim 3, wherein, when it has been determined in the determination of a correlation between the test fatigue life N_{lab} and the ramp rate Ramp_{lab} that there is a correlation, a linear function representing a normalized test fatigue life N_{lab} using a normalized ramp rate Ramp_{lab} is derived from the function representing the test fatigue life N_{lab} using the ramp rate Ramp_{lab}, m₁ is determined from the slope of the linear function, and the ramp rate term [Ramp_{field}/Ramp_{lab}]^{m1} is calculated.

6. The method of claim 2, further comprising, when it has been determined that the size of the ramp rate RampUp_{lab} and the ramp rate RampDown_{lab} for a rising temperature and a falling temperature in the temperature cycle of the laboratory environment are different, deriving a function representing the test fatigue life N_{lab} using the ramp rate RampUp_{lab} during a rising high temperature and determining a correlation between the test fatigue life N_{lab} and the ramp rate RampUp_{lab} during a rising high temperature, and deriving a function representing the test fatigue life N_{lab} using the ramp rate RampDown_{lab} during a falling low temperature and determining a correlation between the test fatigue life N_{lab} and the ramp rate RampDown_{lab} during a falling low temperature.

7. The method of claim 6, wherein, when it has been determined in the determination of a correlation between the test fatigue life N_{lab} and the ramp rate during a rising high temperature RampUp_{lab} that there is no correlation, m₁ₐ=0 and [RampUp_{field}/RampUp_{lab}]^{m1a}=1 for [RampUp_{field}/RampUp_{lab}]^{m1a} constituting a portion of the ramp rate term [Ramp_{field}/Ramp_{lab}]^{m1}.

8. The method of claim 6, wherein, when it has been determined in the determination of a correlation between the test fatigue life N_{lab} and the ramp rate during a rising high temperature RampUp_{lab} that there is a correlation, a linear function representing a normalized test fatigue life N_{lab} using a normalized ramp rate during a rising high temperature RampUp_{lab} is derived from the function representing the test fatigue life N_{lab} using the ramp rate during a rising high temperature RampUp_{lab}, m₁ₐ is determined for [RampUp_{field}/RampUp_{lab}]^{m1a} constituting a portion of the ramp rate term [Ramp_{field}/Ramp_{lab}]^{m1} from the slope of the linear function, and [RampUp_{field}/RampUp_{lab}]^{m1a} is calculated.

9. The method of claim 6, wherein, when it has been determined in the determination of a correlation between the test fatigue life N_{lab} and the ramp rate during a falling low temperature RampDown_{lab} that there is no correlation, m_{1b}=0 and [RampDown_{field}/RampDown_{lab}]^{m1b}=1 for [RampDown_{field}/RampDown_{lab}]^{m1b} constituting another portion of the ramp rate term [Ramp_{field}/Ramp_{lab}]^{m1}.

10. The method of claim 6, wherein, when it has been determined in the determination of a correlation between the test fatigue life N_{lab} and the ramp rate during a falling low temperature RampDown_{lab} that there is a correlation, a linear function representing a normalized test fatigue life N_{lab} using a normalized ramp rate during a falling low temperature RampDown_{lab} is derived from the function representing the test fatigue life N_{lab} using the ramp rate during a falling low temperature RampDown_{lab}, m_{1b} is determined for [RampDown_{field}/RampDown_{lab}]^{m1b} constituting another portion of the ramp rate term [Ramp_{field}/Ramp_{lab}]^{m1} from the slope of the linear function, and [RampDown_{field}/RampDown_{lab}]^{m1b} is calculated.

11. The method of claim 1, wherein the step for calculating the acceleration factor AF further comprises, when determining the exponent m₂ for the term of the dwell times Dwell_{field} and Dwell_{lab}, determining whether or not a dwell time Dwell_High_{lab} and a dwell time Dwell_Low_{lab} for a high temperature and a low temperature in the laboratory environment for the dwell time Dwell_{lab} are the same or different.

12. The method of claim 11, further comprising, when it has been determined that the dwell time Dwell_High_{lab} and the dwell time Dwell_Low_{lab} for a high temperature and a low temperature in the laboratory environment are the same, deriving a function representing the test fatigue life N_{lab} using a dwell time Dwell_{lab} corresponding to the dwell time Dwell_High_{lab} or the dwell Dwell_Low_{lab} for a high temperature or a low temperature, and determining a correlation between the test fatigue life N_{lab} and the dwell time Dwell_{lab}.

13. The method of claim 12, wherein, when it has been determined in the determination of a correlation between the test fatigue life N_{lab} and the dwell time Dwell_{lab} that there is no correlation, m₂=0 and the dwell time term [Dwell_{field}/Dwell_{lab}]^{m2}=1.

14. The method of claim 12, wherein, when it has been determined in the determination of a correlation between the test fatigue life N_{lab} and the dwell time Dwell_{lab} that there is a correlation, a linear function representing a normalized test fatigue life N_{lab} using a normalized dwell rate Dwell_{lab} is derived from the function representing the test fatigue life N_{lab} using the dwell time Dwell_{lab}, m₂ is determined from the slope of the linear function, and the dwell time term [Dwell_{field}/Dwell_{lab}]^{m2} is calculated.

15. The method of claim 11, further comprising, when it has been determined that the dwell times Dwell_High_{lab} and the Dwell_Low_{lab} for a high temperature and a low temperature in the laboratory environment are different, deriving a function representing the test fatigue life N_{lab} using the dwell time Dwell_High_{lab} for a high temperature and determining a correlation between the test fatigue life N_{lab} and the dwell time Dwell_High_{lab} for a high temperature, and deriving a function representing the test fatigue life N_{lab} using the dwell time Dwell_Low_{lab} for a low temperature and determining a correlation between the test fatigue life N_{lab} and the dwell time Dwell_Low_{lab} for a low temperature.

16. The method of claim 15, wherein, when it has been determined in the determination of a correlation between the test fatigue life N_{lab} and the dwell time at high temperature Dwell_High_{lab} that there is no correlation, m₂a=0 and [Dwell_High_{field}/Dwell_High_{lab}]^{m2a}=1 for [Dwell_High_{field}/Dwell_High_{lab}]^{m2a} constituting a portion of the dwell time term [Dwell_{field}/Dwell_{lab}]^{m2}.

17. The method of claim 15, wherein, when it has been determined in the determination of a correlation between the test fatigue life N_{lab} and the dwell time at high temperature Dwell_High_{lab} that there is a correlation, a linear function representing a normalized test fatigue life N_{lab} using a normalized dwell time at a high temperature Dwell_High_{lab} is derived from the function representing the test fatigue life N_{lab} using the dwell time at a high temperature Dwell_High_{lab}, m₂a is determined for [Dwell_High_{field}/Dwell_High_{lab}]^{m2a} constituting a portion of the dwell time term [Dwell_{field}/Dwell_{lab}]^{m2} from the slope of the linear function, and [Dwell_High_{field}/Dwell_High_{lab}]^{m2a} is calculated.

18. The method of claim 15, wherein, when it has been determined in the determination of a correlation between the test fatigue life N_{lab} and the dwell time at low temperature Dwell_Low_{lab} that there is no correlation, m₂b=0 and [Dwell_Low_{field}/Dwell_Low_{lab}]^{m2b}=1 for [Dwell_Low_{field}/Dwell_Low_{lab}]^{m2b} constituting a portion of the dwell time term [Dwell_{field}/Dwell_{lab}]^{m2}.

19. The method of claim 15 wherein, when it has been determined in the determination of a correlation between the test fatigue life N_{lab} and the dwell time at low temperature Dwell_Low_{lab} that there is a correlation, a linear function representing a normalized test fatigue life N_{lab} using a normalized dwell time at a low temperature Dwell_Low_{lab} is derived from the function representing the test fatigue life N_{lab} using the dwell time at a low temperature Dwell_Low_{lab}, m₂b is determined for [Dwell_Low_{field}/Dwell_Low_{lab}]^{m2b} constituting another portion of the dwell time term [Dwell/Dwell_{field}/Dwell_{lab}]^{m2} from the slope of the linear function, and [Dwell_Low_{field}/Dwell_Low_{lab}]^{m2b} is calculated.

20. A method for predicting the fatigue life of a solder joint in a product joined by soldering, the method comprising the steps of:
establishing a maximum temperature Tₘₐₓ_{_{—}}_{field}, a minimum temperature Tₘᵢₙ_{_{—}}_{field}, and a temperature cycle frequency F_{field} in a field environment of the product;
establishing a maximum temperature Tₘₐₓ _{_{—}}_{lab}, a minimum temperature Tₘᵢₙ_{_{—}}_{lab}, and a temperature cycle frequency F_{lab} in a laboratory environment for accelerated testing of the product;
implementing the accelerated testing of the product to measure a test fatigue life N_{lab} until failure of the product;
determining exponent m₁ for the ramp rate, exponent m₂ for the dwell time, and exponent m₃ for the minimum temperature in Equation 2 below, which is represented using the ramp rate Ramp_{field} and the dwell time Dwell_{field} of the field environment, and the ramp rate Ramp lab and the dwell time Dwell_{lab} of the laboratory environment from profile data of a temperature cycle using the established maximum temperature Tₘₐₓ_{_{—}}_{field}, the minimum temperature Tₘᵢₙ_{_{—}}_{field}, and the temperature cycle frequency F_{field} of the field environment, from profile data of a temperature cycle using the established maximum temperature Tₘₐₓ _{_{—}}_{lab}, the minimum temperature Tₘᵢₙ_{_{—}}_{lab}, and the temperature cycle frequency F_{lab} of the laboratory environment, and from the measured data of the test fatigue life N_{lab}, and calculating an acceleration factor AF by plugging the determined exponents m₁, m₂ and m₃ into Equation 2;
$$\begin{matrix} Equation 2 & \\ AF = {( \frac{Δ {T}_{field}}{Δ {T}_{lab}} )}^{- n} \times {( \frac{{Ramp}_{field}}{{Ramp}_{lab}} )}^{{m}_{1}} \times {( \frac{{Dwell}_{field}}{{Dwell}_{lab}} )}^{{m}_{2}} \times {( \frac{{Tmin}_{field}}{{Tmin}_{lab}} )}^{{m}_{3}} \times {e}^{\frac{{E}_{a}}{R} ( \frac{1}{{T}_{max\_field}} - \frac{1}{{T}_{max\_lab}} )} & ( Equation 2 )\end{matrix}$$
ΔT_{field}=Tₘₐₓ_{_{—}}_{field}−Tₘᵢₙ_{_{—}}_{field}
ΔT_{lab}=Tₘₐₓ_{_{—}}_{lab}−Tₘᵢₙ_{_{—}}_{lab}
n: Constant Determined By Solder
Eₐ: Activation Energy
R: Boltzmann Constant
and calculating a field fatigue life N_{field} of the product from the calculated acceleration factor AF and the test fatigue life N_{lab} (N_{field}=AF×N_{lab}).
